(19) United States
(12) Patent Application Publication
(10) Pub. No.: US 2005/0245254 A1
(43) Pub. Date: Nov. 3, 2005

(54) Wireless access point (WAP)

(76) Inventor: Lawrence Alton Hall, Harrisburg, PA (US)

Correspondence Address: BARLEY SNYDER, LLC, 1000 WESTLAKES DRIVE, SUITE 275, BERWYN, PA, 19312, US

(21) Appl. No.: 10/835,222

(22) Filed: Apr. 29, 2004

(51) Int. Cl. H04Q 7/24

(52) U.S. Cl. 455/426.1; 455/575.1

(57) ABSTRACT

A wireless access point system provides a wireless access zone as part of a home communication network. A power injector is provided proximate a router/switch for a home communication network to inject power into a cable run extending from the router/switch to a remote location for the wireless access zone. A wireless access point assembly is mounted in a ceiling or wall to provide the wireless access zone. The wireless access point assembly includes an active access point and a power extractor connectable to the cable run to separately provide power and a communication link from the cable run to the active access point.

### FIELD OF THE INVENTION

The invention relates to a wireless access point (WAP) and more particularly to an apparatus and method for integrating a wireless access point into a home network.

### BACKGROUND OF THE INVENTION

Wireless access points (WAP's), such as the model WA840G, available from Motorola, Inc. of Schaumburg, Ill., are known for providing one or more computers with access to a computer network and/or to the Internet, using radio frequency (RF) transmissions. While these WAP's provide mobility, especially for laptop computers, and accessibility to alternate locations without running hardwires, they suffer from several limitations. Existing Warp's need to rest on a flat surface, taking-up space on a shelf or piece of furniture, and creating an unappealing esthetic. WAP's require a line of sight for RF transmission, limiting their placement relative to furniture and other obstructions. Also, WAP's require power, limiting their placement to locations where electric power is available.

### SUMMARY OF THE INVENTION

According to an exemplary embodiment of the invention, a wireless access point assembly is provided for connection to a network cable run carrying power and communication signals on wires therein to provide a wireless zone as part of a home communications network. The wireless access point assembly comprises a wireless access point, a power extractor, a power injector, an antenna, and a housing. The power extractor has a connector configured to receive the cable carrying power and communication signals and separate output connectors for the power the communication signals. The antenna is operatively associated with the wireless access point. The housing is configured to be mountable in a ceiling or wall and to receive the wireless access point, antenna, and the power extractor.

### BRIEF DESCRIPTION OF THE DRAWINGS

The invention will be described with reference to the accompanying drawings, of which:

FIG. 1 is a sectional view of a house showing a home communications network with a wireless access point according to an exemplary embodiment of the invention;

FIG. 2 shows a home network known in the prior art;

FIG. 3 shows a service center and a power injector according to an exemplary embodiment of the invention;

FIG. 4 is an exploded view of a wireless access point assembly according to an exemplary embodiment of the invention;

FIG. 5 shows a power extractor according to an exemplary embodiment of the invention;

FIG. 6 shows unassembled components of a wireless access point assembly according to an exemplary embodiment of the invention; and

FIG. 7 shows an exemplary wireless access point assembly with the mounting bracket and dome omitted.

### DETAILED DESCRIPTION OF THE INVENTION

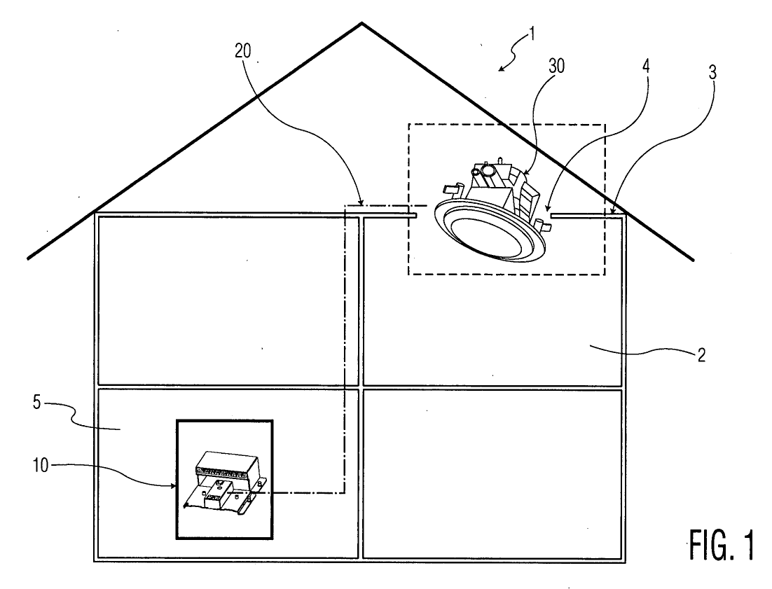

The invention provides a wireless access point assembly, a modular wireless access point system, and a wireless networking system to form a wireless zone as part of a home communication network. As shown in FIG. 1, a home 1 is provided with a communication network, which includes a service center 10, and at least one cable run 20, extending from the service center 10 to a location remote from the service center 10. According to an exemplary embodiment of the invention, a wireless access point (WAP) assembly 30 is connected to the cable run 20 to form a wireless zone 2. The WAP assembly 30 is mounted in an opening 4 in a ceiling 3 of the home 1, essentially centrally located in the wireless zone 2. By locating the WAP 30 in the ceiling 3, it can be essentially transparent to the homeowner, allowing a more esthetically pleasing room layout than if an existing WAP were simple placed on a table.

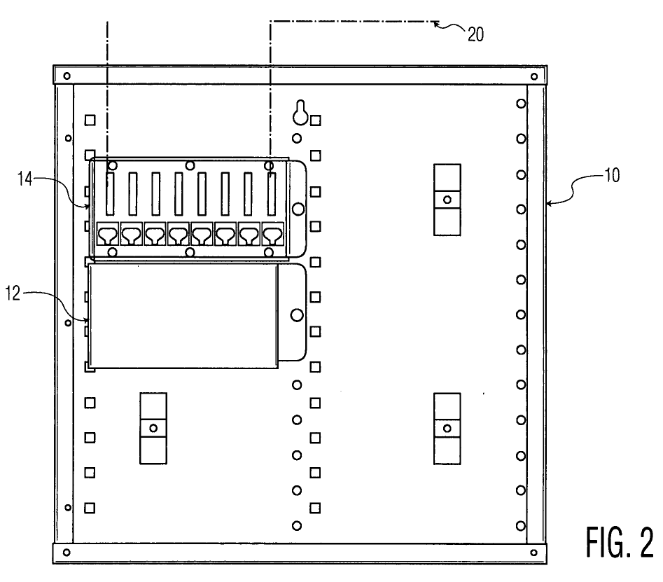

The communications network, may be, for example, an OnQ Home Network System, as shown in FIG. 2, available from OnQ Technologies, Inc. of Middletown, Pa. The service center 10 includes a router/switch 12 that connects to a broadband digital service and to a network interface 14, which is connected to one or more cable runs 20 extending to locations remote from the service center 10. In an exemplary embodiment of the invention, the cable runs 20 are Category 5 high-performance cabling, typically used for digital communication networks.

The WAP 30 is powered from the service center 10 over the cable run 20, as shown in FIG. 1. This eliminates the need to locate the WAP 30 near a power source, allowing the WAP 30 to be located, instead for efficiency and other factors. In addition, providing power to the WAP 30 over cable run 20 eliminates the need to have cross trade involvement in the installation of the WAP 30. If, for example, power cables were separately run to the location for the WAP 30, then the installer would have to rely on an electrician for wiring for power. Thus, transmitting power to the WAP assembly 30 over cable run 20 facilitates easy installation.

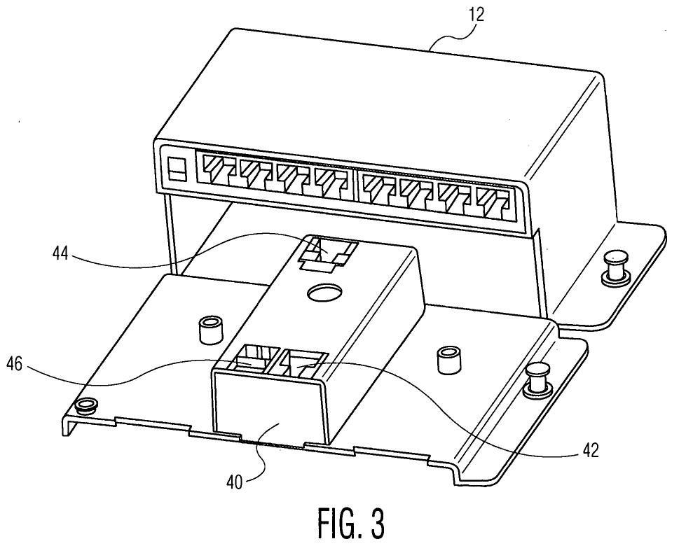

A WAP system may be added to a known networking system to provide a wireless access zone 2. The WAP system consists of two primary components, a Power Injector 40 (shown in FIG. 3) and the WAP assembly 30. In an exemplary embodiment of the invention, the WAP system uses the OnQ Service Center 10 and Hardwired Network Products or cable runs 20 as a foundation. The resulting network system is a hybrid wired and wireless solution to expand the network capability in the home.

As shown in FIG. 3, the power injector 40 is located proximate the router/switch 12. In an exemplary embodiment of the invention, the power injector 40 may conform to the footprint of an existing modular component of the OnQ Network System and utilize an existing mounting structure. For example the power injector 40 may be mounted to an OnQ Telecom Service Conditioning module, and have a form factor similar to the Data Surge Conditioning Unit. The Power Injector includes a power supply (not shown) and connectors 42, 44, 46. The connectors include: a communication signal input connector 42 (operatively connected to an external broadband cable either before or after the router/switch 12), a communication signal output connector 44 (for connection to the cable run 20), and a power input connector 46 (for injecting power onto the cable run 20 going to the WAP assembly 30). The power injector 40 may optionally include surge protection on the communication pairs.

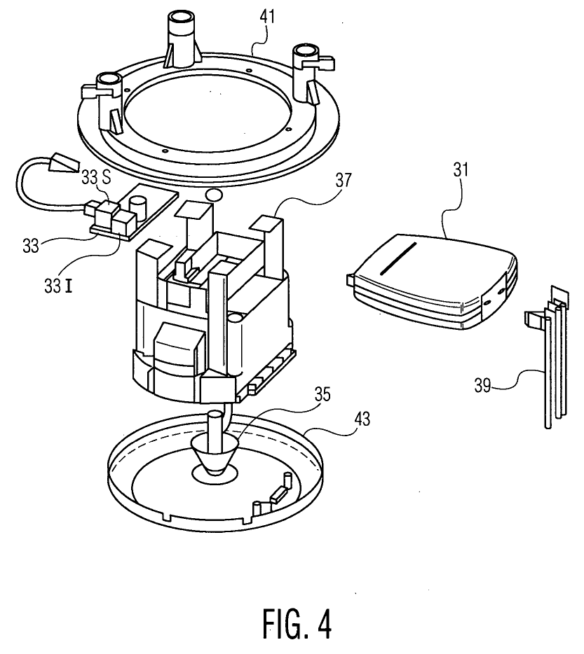

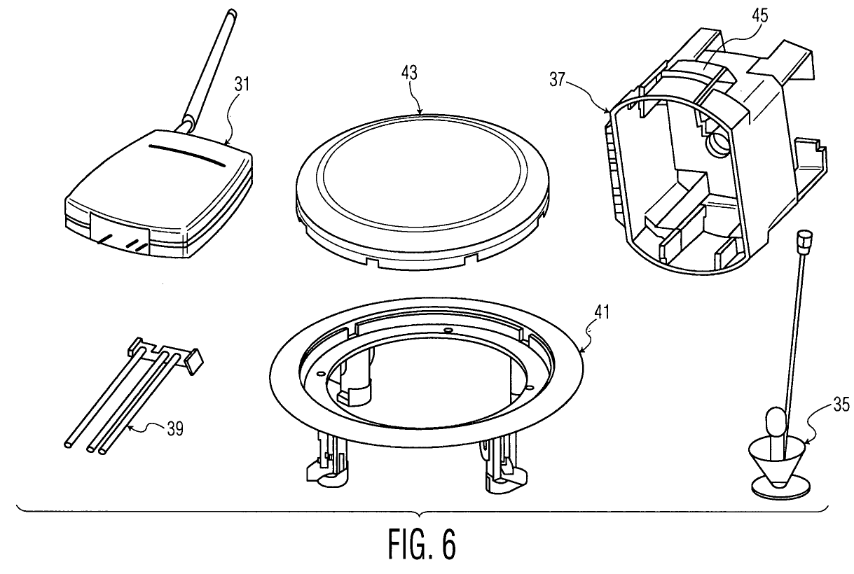

As shown in FIG. 4, The WAP assembly 30 has four primary components, the active access point 31, the power extractor 33, the antenna 35, and the mounting mechanism or housing 37. These components may be integrated at various levels. To allow the product to be near transparent to the homeowner, it is to configured like an in-ceiling speaker or smoke detector. Mounting the WAP assembly 30 centrally in the house and in the ceiling provides good coverage and performance. In an exemplary embodiment of the invention, the WAP assembly 30 conforms to the footprint of a 6½ inch in-ceiling speaker, and uses a standard mounting bracket 41, as shown in FIG. 6. The active access point 31 is received in the housing 37. Then, the housing 37 is fitted into the mounting bracket 41 and a dome 43 is placed over the housing 37 and active access point 31 and attached to the mounting bracket 41.

In an exemplary embodiment of the invention, the antenna 35 is configured to fit the grill area of the housing 37 beneath the dome, corresponding to the cover of a speaker. The antenna 35 may be an omni directional antennae and provide additional gain. In addition, the antenna 35 may provide support for LED's to provide status feed back to the homeowner. Alternatively, the antenna may be disposed within the housing 37 with a cosmetic cover mounted on the housing.

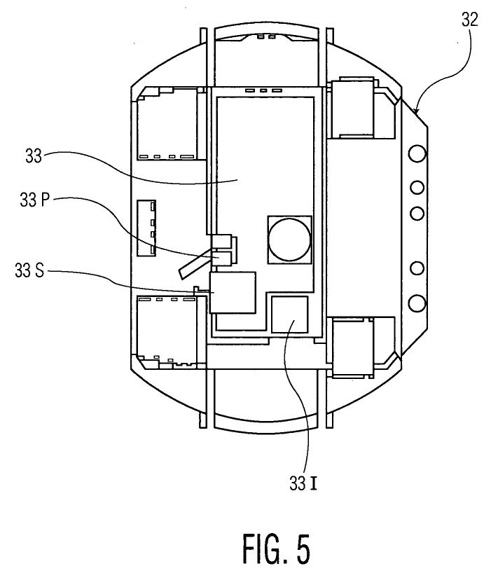

The power extractor 33, as shown in FIG. 5, is similar in configuration to the power injector 40. It has an input connector 33I, which receives a connector on an end of the cable run 20. The wires carrying the communication signal in the cable run 20 are connected to a signal connector 33S by wires or traces internal to the power extractor 33. The wires carrying power in the cable run 20 are connected to a power connector 33P by wires or traces internal to the power extractor 33. The power connector 33P is then connected by a power cable or other cable means to the power input of the active access point 31 of the WAP assembly 30.

In an exemplary embodiment of the invention, the active access point 31 is an approved 802.11g access point. The key specifications for the active access point 31 are outlined in Table A, below. The product must be configurable to perform as a wireless access point or as a repeater to another wireless access point or wireless router. Configured as a repeater, the active access point 31 extends the wireless signal, this is necessary to support installations in which obstacles like appliances, furnishings, or architectural obstacles inhibit the wireless signal from reaching its desired destination. Configured as an access point, it is fully compatible with the IEEE 802.11g standard, so it works with existing 802.11b-compliant devices.

The WAP system of the invention provides a robust wireless zone 2 in the home 1. It takes into consideration the residential environment, including typical constructions, furniture, appliances, and other RF sources.

TABLE A
(Access Point Specifications)

| | |
|---|---|
| Standards | IEEE 802.11 g |
| | IEEE 802.3 |
| | IEEE 802.3 |
| | IEEE 802.3 u |
| Ports | 10/100 Mbps Fast Ethernet |
| Media Access Control | CSMA/CA with ACK |
| Modulation Technology | Orthogonal Frequency |
| | Division Multiplexing (OFDM) |
| | Complementary Code Keying (CCK) |
| Data Rates, | 54 Mbps |
| Automatic Fallback | 48 Mbps |
| | 36 Mbps |
| | 24 Mbps |
| | 18 Mbps |
| | 12 Mbps |
| | 11 Mbps |
| | 9 Mbps |
| | 6 Mbps |
| | 5.5 Mbps |
| | 2 Mbps |
| | 1 Mbps |
| Receiver Sensitivity | 54 Mbps OFDM |
| | 48 Mbps OFDM |
| | 36 Mbps OFDM |
| | 24 Mbps OFDM |
| | 18 Mbps OFDM |
| | 12 Mbps OFDM |
| | 11 Mbps CCK |
| | 9 Mbps OFDM |
| | 6 Mbps OFDM |
| | 5.5 Mbps CCK |
| | 2 Mbps QPSK |
| | 1 Mbps BPSK |
| Device Management | Web-Based - Internet Explorer v6 or later; |
| | Netscape Navigator v6 or later |
| Power Input | External Power Supply DC 5 V, 2.5 A |
| LED's | Power (Green) |
| | WLAN (Yellow) |
| Safety & Emissions | FCC |
| | UL |
| Security | 64-, 128-WEP |
| | 802.1x |
| | WPA² - 3 Wi-Fi Protected Access |
| Temperature | Operating: 32° F. to 131° F. (0° C. to 55° C.) |
| | Storing: 4° F. to 167° F. (20° C. to 75° C.) |
| Humidity | 95% maximum (non-condensing) |
| Frequency Range | 2.4 GHz to 2.462 GHz |
| Transmitter Output | 15 dBm ± 2 dB |
| Power | |
| External Antenna Type | 2.5 dB gain with reverse SMA connector |
| Over-Driving Levels | Tolerates up to +17 dBm at the antenna |
| Range | Indoors: Up to 328 feet (100 meters) |
| | Outdoors: Up to 1,312 feet (400 meters) |
| Frequency range | 2.4-2.5 GHz |
| Gain | 4 dBi |
| VSWR | 1.8:1 Max |
| Polarization | Linear, vertical |
| HPBW | Horizontal - 360° |
| | Vertical—63° (each lobe, 2 lobes) |
| Downtilt | 40° |
| Power handling | 20W (cw) |
| Impedance | 50 Ohms |
| Connector | SMA female |
| Radom color | White |
| Radom material | ABS |

The cable run 20 comprises a plurality of twisted wire pairs. In an exemplary embodiment of the invention, the cable run 20 comprises category 5 cable having RJ-45 connectors on both ends thereof. At least one twisted pair being available for transmission of power.

The WAP system of the invention is intended to be a professionally installed system and is intended to work with an OnQ Structured Wiring system 10. The application is for traditional residential buildings, either single family or multi-dwelling units. The WAP system may optionally be provided as a preconfigured upgrade to a core networking system. Installation and set-up of the WAP system may be performed through an included Installation Wizard, and/or Web browser. The installation application preferably supports the following: Windows® 98/98SE/Me/2000/XP Home or XP Professional for use of the Installation Wizard. Optionally the installation application further supports Apple based personal computers.

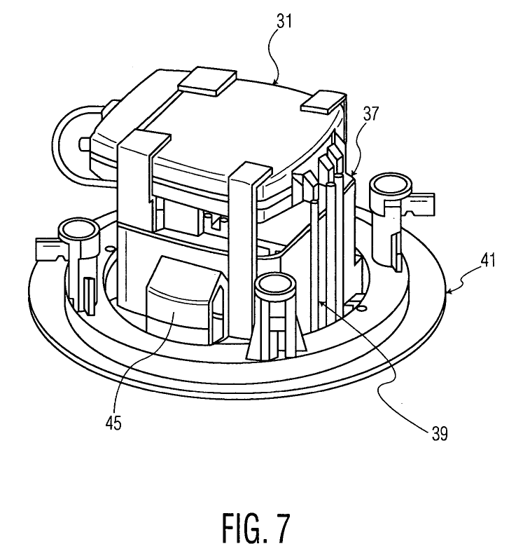

The WAP system may be efficiently installed by a single installer. Installation includes system design for the home. The installer may easily determine the best locations for the WAP assembly 30 and repeaters, based on the size and shape of rooms and the locations of obstacles, such as furniture and walls. The system can be installed such that it is nearly transparent to the homeowner, yet accessible for easy feedback. The exposed parts of the system (e.g., WAP assembly housing 37 with a built-in antenna 35) may be configured to blend into a variety of homes and decors. light-emitting diodes (LED's) may be provided on the active access point 31 to indicate power to the active access point 31 and a communication link with the active access point 31. Light pipes 39 may be provided to convey light from the LED's to an exposed surface of the housing 37, as shown in FIG. 7. The homeowner can walk up to the WAP assembly 30 and determine from the indicator LED's whether there is power and link communication. Also, as shown in FIG. 7, the housing 37 may comprise a latch 45 for engaging the mounting bracket 41.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. A wireless access point assembly for connection to a network cable run carrying power and communication signals on wires therein to provide a wireless zone as part of a home communications network, the wireless access point assembly comprising:
a wireless access point;
a power extractor having a connector configured to receive the cable carrying power and communication signals and output connectors for power and communication signals;
an antenna operatively associated with the wireless access point; and
a housing mountable in a ceiling or wall and configured to receive the wireless access point and the power extractor.

2. The wireless access point of claim 1 wherein the antenna is formed as a grill for the housing.

3. The wireless access point of claim 1 wherein the housing conforms to a footprint for a 6.5 inch in-ceiling speaker.

4. The wireless access point of claim 1, further comprising an indicator light for indicating the presence of at least one of: power, a signal transmission on the cable, and a wireless signal transmission.

5. The wireless access point of claim 4, further comprising light pipes to convey light from the indicator light to the antenna or the housing for viewing from external the wireless access point.

6. A wireless access point system for use with a home communications network, the wireless access point system comprising:
an active access point for forming a wireless access zone;
a communications network router or switch for directing a communication signal to and from the active access point;
a cable run operatively connected to the communications network router or switch and to the active access point to transmit communications signals therebetween;
a power injector located proximate to and operatively connected with the communications network router or switch and having a power supply for electrically connecting with the cable run to supply power to the active access point over the cable run; and
a power extractor located proximate to and electrically connecting with the active access point for extracting power from the cable run to provide a separate power output and communication link.

7. The wireless access point system of claim 6 wherein the cable run comprises a category 5 cable.

8. The wireless access point system of claim 6 wherein the active access point and the power extractor are assembled in a wireless access point assembly.

9. The wireless access point system of claim 8 wherein the wireless access point assembly includes a housing configured to be mounted in a ceiling.

10. The wireless access point system of claim 9 wherein the housing conforms to a footprint for a 6.5 inch in-ceiling speaker.

11. The wireless access point system of claim 9 wherein the wireless access point assembly includes an antenna.

12. The wireless access point system of claim 11 wherein the antenna is formed into a grill of the housing.

13. A modular wireless access point system for use with a home network having a network router or switch and at least one cable run between the network router or switch to form a wireless access zone at a location remote from the network router or switch, the modular wireless access system comprising:
a power injector having a power supply and configured to be operatively associated with the cable run proximate the network router or switch to supply power over the cable run; and
a wireless access point assembly having a active access point for transmitting and receiving communication signals and a power extractor operatively associated with the cable run to transmit power from the cable run to the wireless access point, the wireless access point assembly being configured for mounting in a wall or ceiling.

14. The modular wireless access point system of claim 13 wherein the power injector conforms to the footprint of a modular component for the home network.

15. The modular wireless access point system of claim 13 wherein the wireless access point assembly conforms to a footprint for a 6.5 inch in-ceiling speaker.

16. The modular wireless access point system of claim 13 wherein the cable run comprises a plurality of twisted wire pairs
